(19) United States
(12) Patent Application Publication
(10) Pub. No.: US 2025/0267392 A1
(43) Pub. Date: Aug. 21, 2025

(54) EAR-WEARABLE ELECTRONIC DEVICE INCLUDING ACOUSTIC FILTER

(71) Applicant: Starkey Laboratories, Inc., Eden Prairie, MN (US)

(72) Inventors: Viktor Klymko, Minneapolis, MN (US); Lillian Charlotte Kelly, Bloomington, MN (US); Joshua Braband, Minneapolis, MN (US); Benjamin Durand Johnson, Blaine, MN (US)

(21) Appl. No.: 19/053,795

(22) Filed: Feb. 14, 2025

Related U.S. Application Data
(60) Provisional application No. 63/555,212, filed on Feb. 19, 2024.

(51) Int. Cl. H04R 1/22; H04R 1/08; H04R 25/00

(52) U.S. Cl. CPC H04R 1/222; H04R 1/08; H04R 25/48

(57) ABSTRACT

Various embodiments of an ear-wearable electronic device are disclosed. The device includes a housing having a top shell and a bottom shell, a microphone disposed within the housing, and an acoustic path disposed at least partially within the housing and extending between an acoustic port disposed at an outer surface of the housing and an outlet disposed within the housing that acoustically couples the acoustic path to an inlet of the microphone. The device further includes an acoustic filter disposed at least partially within an inner surface of the top shell and includes a neck and a resonance cavity acoustically coupled to the neck. The acoustic filter is acoustically coupled to the acoustic path via the neck. Further, the acoustic filter is configured to reduce an intensity of acoustic waves sensed by the microphone in a first frequency range.

This application claims the benefit of U.S. Provisional Application No. 63/555,212, filed Feb. 19, 2024, the disclosure of which is incorporated by reference herein in its entirety.

### BACKGROUND

Ear-wearable electronic devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of acoustic waves to the wearer's ear canal from a controller either disposed within the housing of the hearing device or connected to the hearing device by a wired or wireless connection. This acoustic information can include music or speech from a recording or other source, e.g., ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable electronic device that includes an acoustic filter disposed at least partially within a housing of the device. The acoustic filter is acoustically coupled to an acoustic path of the device by a neck that is acoustically coupled to a resonance cavity of the filter. The acoustic filter is configured to reduce an intensity of acoustic waves sensed by a microphone of the device in a first frequency range, e.g., an ultrasonic frequency range.

In one aspect, the present disclosure provides an ear-wearable electronic device including a housing having a top shell and a bottom shell, a microphone disposed within the housing and having an inlet, and an acoustic path disposed at least partially within the housing between the top and bottom shells and extending between an acoustic port disposed at an outer surface of the housing and an outlet disposed within the housing that acoustically couples the acoustic path to the inlet of the microphone. The device further includes an acoustic filter disposed at least partially within an inner surface of the top shell, where the acoustic filter includes a neck and a resonance cavity acoustically coupled to the neck. The acoustic filter is acoustically coupled to the acoustic path via the neck. Further, the acoustic filter is configured to reduce an intensity of acoustic waves sensed by the microphone in a first frequency range.

In another aspect, the present disclosure provides an ear-wearable electronic device including a faceplate having an outer surface and an inner surface, where the faceplate defines a pocket disposed in the inner surface of the faceplate; and a microphone disposed at least partially within the pocket and including an inlet disposed within the pocket. The device also includes an acoustic path disposed at least partially within the faceplate and extending between an acoustic port disposed at the outer surface of the faceplate and an outlet disposed in the pocket, where the acoustic path is acoustically coupled to the inlet of the microphone via the outlet; and an acoustic filter disposed at least partially within the faceplate, where the acoustic filter includes a neck and a resonance cavity acoustically coupled to the neck. Further, the acoustic filter is acoustically coupled to the acoustic path via the neck. The acoustic filter is configured to reduce an intensity of acoustic waves sensed by the microphone in a first frequency range.

In another aspect, the present disclosure provides a method of forming an ear-wearable electronic device, including disposing a microphone within a housing, where the housing includes a top shell and a bottom shell; disposing an acoustic path at least partially within the housing such that it extends between an acoustic port disposed at an outer surface of the housing and an outlet disposed within the housing that acoustically couples the acoustic path to an inlet of the microphone; and disposing an acoustic filter at least partially within an inner surface of the top shell of the housing. The acoustic filter includes a neck and a resonance cavity acoustically coupled to the neck. The acoustic filter is acoustically coupled to the acoustic path via the neck. Further, the acoustic filter is configured to reduce an intensity of acoustic waves sensed by the microphone in a first frequency range.

In another aspect, the present disclosure provides a method of forming an ear-wearable electronic device, including disposing a pocket in an inner surface of a faceplate; disposing a microphone at least partially within the pocket such that an inlet of the microphone is disposed within the pocket; and disposing an acoustic path at least partially within the faceplate, where the acoustic path extends between an acoustic port disposed at an outer surface of the faceplate and an outlet disposed in the pocket. The acoustic path is acoustically coupled to the inlet of the microphone via the outlet. The method further includes disposing an acoustic filter at least partially within the faceplate. The acoustic filter includes a neck and a resonance cavity acoustically coupled to the neck. Further, the acoustic filter is acoustically coupled to the acoustic path via the neck, and the acoustic filter is configured to reduce an intensity of acoustic waves sensed by the microphone in a first frequency range.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic cross-section view of a housing of the electronic device of FIG. 1.

FIG. 3 is a schematic top view of a portion of the housing of the electronic device of FIG. 1 with a top shell of the device rendered transparent for clarity.

FIG. 4 is a schematic perspective view of the portion of the housing of the electronic device shown in FIG. 3.

FIG. 5 is a schematic cross-section view of another portion of the housing of the electronic device of FIG. 1.

FIG. 6 is a schematic side view of an acoustic path and an acoustic filter acoustically coupled to the acoustic path of the electronic device of FIG. 1.

FIG. 7 is a schematic top view of the acoustic path and the acoustic filter of FIG. 6.

FIG. 8 is a plot of sensitivity versus frequency for simulated sensitivity of microphones with acoustic paths that are acoustically coupled to the microphones for the electronic device of FIG. 1.

FIG. 9 is a schematic perspective view of another embodiment of an ear-wearable electronic device.

FIG. 10 is a schematic side view of the electronic device of FIG. 9.

FIG. 11 is a schematic cross-section view of a faceplate and one or more electronic components of the electronic device of FIG. 9.

FIG. 12 is a schematic cross-section view of an acoustic path, pocket, and acoustic filter of the electronic device of FIG. 9 that are disposed at least partially within the faceplate.

FIG. 13 is a schematic cross-section view of the acoustic path and acoustic filter of the electronic device of FIG. 9 in isolation with the faceplate removed.

FIG. 14 is a plot of sensitivity versus frequency for simulated sensitivity of microphones with acoustic paths that are acoustically coupled to the microphones for the electronic devices of FIG. 9.

FIG. 15 is a flowchart of one embodiment of a method of forming the ear-wearable electronic device of FIG. 1.

FIG. 16 is a flowchart of one embodiment of a method of forming the ear wearable electronic device of FIG. 9.

FIG. 17 is a schematic block diagram of another embodiment of an ear-wearable electronic device.

### DETAILED DESCRIPTION

In general, the present disclosure provides various embodiments of an ear-wearable electronic device that includes an acoustic filter disposed at least partially within a housing of the device. The acoustic filter is acoustically coupled to an acoustic path of the device by a neck that is acoustically coupled to a resonance cavity of the filter. The acoustic filter is configured to reduce an intensity of acoustic waves sensed by a microphone of the device in a first frequency range, e.g., an ultrasonic frequency range.

Ear-wearable electronic devices such as hearing devices can include an acoustic path that can undesirably have a natural quarter-wavelength resonance at ultrasonic frequencies of between about 20 kHz and about 40 kHz. This resonance can amplify the sensitivity of a microphone of the device that may sometimes interfere with a sampling frequency of a digital signal processing (DSP) circuit of the device. Such interference can produce an audible “crackling” artifact in acoustic waves that are directed to a wearer by a receiver or speaker of the device. As a result, it may be preferred to remove or reduce these ultrasonic resonances in the acoustic waves provided to the wearer.

Various techniques have been attempted to reduce ultrasonic resonances caused by the acoustic path. For example, a length of the acoustic path can be shortened by reducing a distance from an acoustic port at an outer surface of the device to the microphone. Such shortening of the acoustic path can increase a resonance frequency of the path beyond 32 kHz, which can be approximately equal to ⅓ of a sampling frequency of a processor (96 kHz). When an audio signal from the microphone is digitized by the processor, an ultrasonic noise can be present in the digital signal, thereby causing a crackling sound in the audio signal when the digital signal from the processor is converted back to an analog signal. Such crackling sound can be loud and unpleasant for the wearer. A similar effect can occur when the resonance frequency of the acoustic path is approximately equal to ¼ of the sampling frequency of the processor, e.g., 24 kHz, or at any other simple fraction of the sampling frequency.

One or more embodiments of ear-wearable electronic devices described herein can provide various advantages over currently-available devices. For example, one or more embodiments of devices described herein can include one or more acoustic filters that are acoustically coupled to an acoustic path of the device. Each acoustic filter can be configured to reduce an intensity of acoustic waves sensed by the microphone in one or more frequency ranges. In one or more embodiments, such frequency range can be at least 20 kHz and no greater than 50 kHz, thereby reducing or removing at least a portion of the ultrasonic frequencies that may reach the microphone. Such frequency reduction can minimize undesirable ultrasonic resonances in the acoustic waves that are directed to the wearer by a receiver of the device that are based on one or more signals provided by the microphone to digital signal processing circuitry of the device. Use of one or more acoustic filters can also enable a longer acoustic path that can enable greater design freedoms for the overall device. Further, even if the resonance of the acoustic path falls between 20 kHz and 50 kHz, the acoustic filter can be designed to compensate for such ultrasonic resonance by shifting the resonance down to a frequency where increased microphone sensitivity would not be as much of a concern.

The acoustic filter can be acoustically connected to any suitable portion or portions of the acoustic path. Further, the acoustic filter can take any suitable shape and have any suitable dimensions.

The acoustic filter can employ any suitable technique to assist in reducing the intensity of these acoustic waves that are sensed by the microphone. For example, the acoustic filter can act as an ultrasonic energy absorber by accumulating energy of the ultrasonic resonances of the acoustic path. As a result, a sound pressure level of these ultrasonic resonances at the microphone inlet can be reduced. In one or more embodiments, the acoustic filter can be configured to reduce an intensity of acoustic waves sensed by the microphone at other frequency ranges to provide a stop-band filter that can minimize noise of selected frequencies.

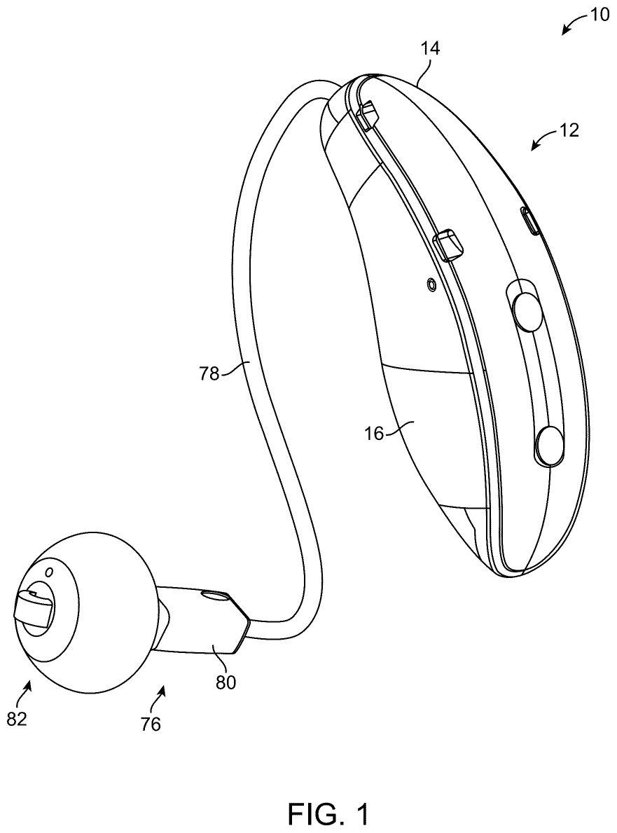

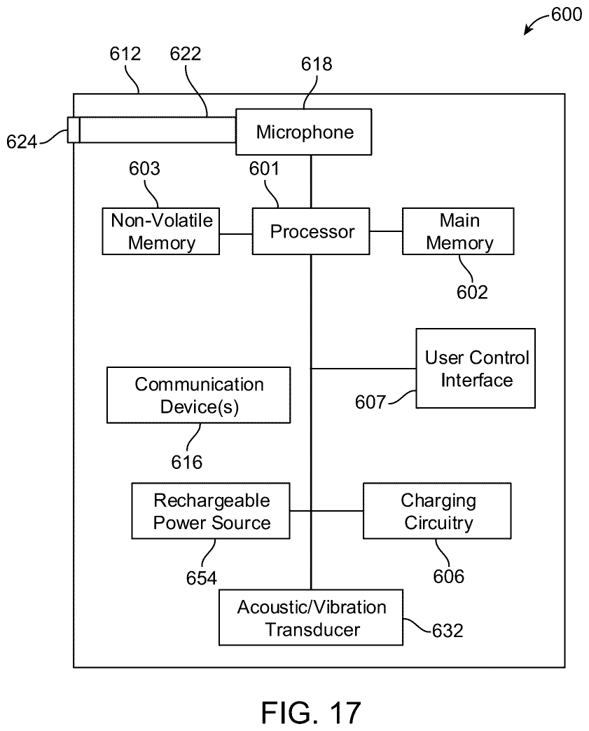

FIGS. 1-5 are various views of one embodiment of an ear-wearable electronic device 10. The ear-wearable device 10 is a behind-the-ear (BTE) type device and thus includes a housing 12 that is operable to be worn on or behind an ear of a wearer. The device 10 can include any suitable electronic circuitry or components, e.g., the electronic circuitry and components of ear-wearable electronic device 600 of FIG. 17.

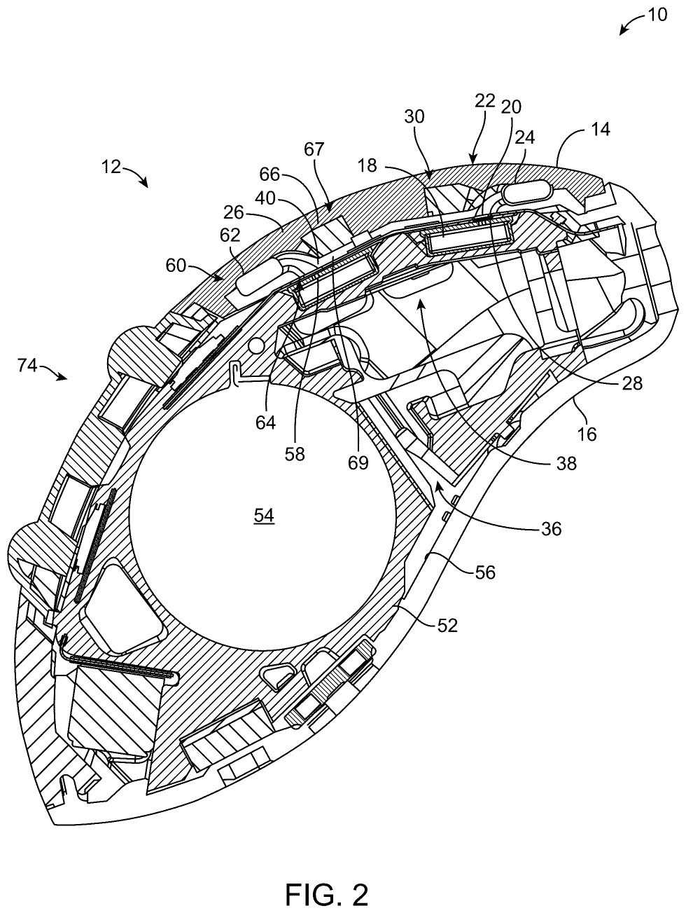

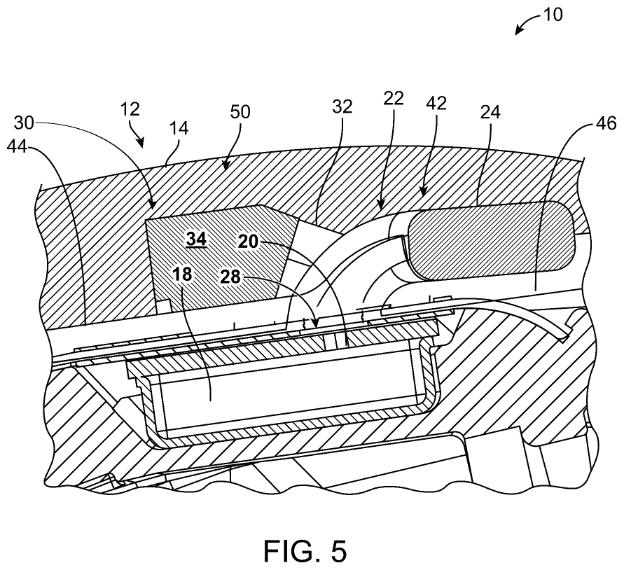

The housing 12 includes a top shell 14 and a bottom shell 16. As shown in FIG. 2, which is a schematic cross-section view of the housing 12 of the device 10, a microphone 18 is disposed within the housing 12 and includes an inlet 20. An acoustic path 22 is disposed at least partially within the housing 12 between the top and bottom shells 14, 16 and extends between an acoustic port 24 disposed at an outer surface 26 of the housing and an outlet 28 (FIG. 5) disposed within the housing that acoustically couples the acoustic path to the inlet 20 of the microphone 18. The device 10 further includes an acoustic filter 30 disposed at least partially within an inner surface 44 (FIG. 5) of the top shell 14. The acoustic filter 30 includes a neck 32 and a resonance cavity 34 acoustically coupled to the neck. As used herein, the term “acoustically coupled” means fluidically coupled or that any barrier positioned between two or more elements or components that are acoustically coupled is generally acoustically transparent for frequencies of interest, where acoustically transparent means that the element or component attenuates sound at a sound pressure level of no greater than 6 dB.

The acoustic filter 30 is acoustically coupled to the acoustic path 22 via the neck 32. Further, the acoustic filter 30 is configured to reduce an intensity of acoustic waves sensed by the microphone 18 in a first frequency range as is further described herein.

The housing 12 of the device 10 can take any suitable shape and having any suitable dimensions. In one or more embodiments, the housing 12 is configured to rest against a wearer's outer ear in a behind-the-ear orientation. The housing 12 can be manufactured by, for example, injection-molding, 3D printing, etc. The housing 12 can also include any suitable materials, e.g., inorganic (e.g., metallic, ceramic) or polymeric materials. In one or more embodiments, the housing 12 can include at least one of silicone, urethane, acrylate, flexible epoxy, or acrylated urethane materials.

In the illustrated embodiment, the housing 12 includes the top shell 14 and the bottom shell 16. For purposes of this disclosure, the terms “top,” “bottom,” “above,” “below,” “front,” “back,” etc. are not intended to indicate a required orientation of use relative to the ground or other reference point. Generally, these terms are intended to help distinguish locations relative to an arbitrary reference point and may correspond to the orientation in the drawings, but no limitation is intended by the use of these terms.

The top shell 14 can be connected to the bottom shell 16 using any suitable technique. In one or more embodiments, the top shell 14 can be removably connected to the bottom shell 16 using any suitable technique, e.g., adhering, snap fitting, press fitting, mechanically fastening, welding, etc.

The top and bottom shells 14, 16 form an enclosure 36 that, once assembled, holds electronic components 38. For example, the device 10 includes the microphone 18 disposed within any suitable portion of the housing 12. In one or more embodiments, the microphone 18 can be disposed on a frame 52 that is disposed within the housing 12 between the top shell 14 and the bottom shell 16. The frame 52 can take any suitable shape and have any suitable dimensions. Further, the frame 52 can be configured to support other electronic components such as battery 54.

The microphone 18 includes the inlet 20. Further, the microphone 18 can include any suitable microphone, e.g., a MEMS microphone, an electret condenser microphone, co-joined microphone sets, etc. The device 10 can include any suitable number of microphones. In one or more embodiments, the device 10 includes a second microphone 40 as is further described herein. The microphone 18 can be configured to convert acoustic waves that enter the microphone through its inlet 20 into one or more electric signals that are directed to a controller or processor (e.g., processor 601 of ear-wearable electronic device 600 of FIG. 17) disposed within the housing 12 or remotely from the housing by a wired or wireless connection.

Disposed at least partially within the housing 12 between the top and bottom shells 14, 16 is the acoustic path 22. In one or more embodiments, the acoustic path 22 can be disposed entirely within the housing 12. In one or more embodiments, the acoustic path 22 can be disposed at least partially within an inner surface 44 of the top shell 14. In one or more embodiments, the acoustic path can be disposed at least partially within an inner surface 56 of the bottom shell 16. In one or more embodiments, the acoustic path 22 can be formed by a concavity 42 disposed in an inner surface 44 of the top shell 14 and a gasket 46 connected to the inner surface of the top shell as is shown in FIG. 5. The gasket 46 can take any suitable shape and have any suitable dimensions. The gasket 46 can be a single continuous piece or multiple pieces. Further, the gasket 46 can include any suitable material, e.g., at least one of an inorganic (e.g., metallic, ceramic) material or a polymeric material. Further, in one or more embodiments, the gasket 46 can be sealed to the inner surface 44 of the top shell 14 such that that acoustic path 22 is entirely enclosed by the top shell 14 and the gasket.

As can be seen in FIG. 5, which is a schematic cross-section view of a portion of the housing 12 of the device 10, the acoustic path 22 extends between the acoustic port 24 that is disposed at the outer surface 26 of the housing 12 (FIG. 2) and the outlet 28 disposed within the housing. The outlet 28 acoustically couples the acoustic path 22 to the inlet 20 of the microphone 18 using any suitable technique.

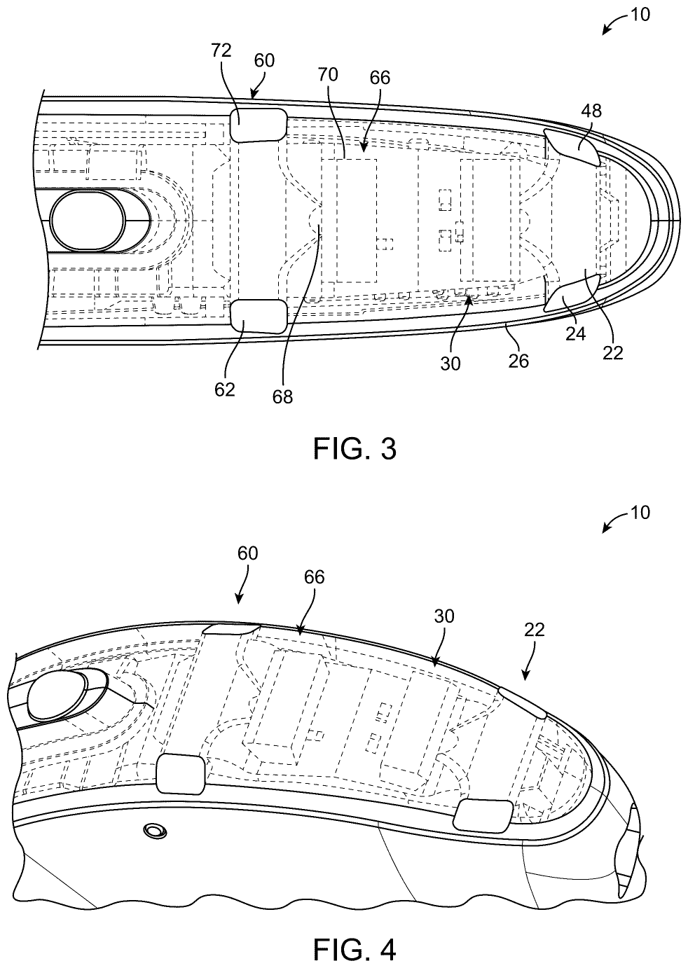

The acoustic path 22 can include any suitable number of acoustic ports 24 disposed in any suitable portion or portions of the outer surface 26 of the housing 12. For example, as shown in FIG. 3, the acoustic path 22 includes the acoustic port 24 and a second acoustic port 48 also disposed at the outer surface 26 of the housing. In embodiments where the acoustic path 22 includes two or more acoustic ports, the acoustic port 24 can define a first acoustic port. The first and second acoustic ports 24, 48 can take any suitable shape and have any suitable dimensions. Further, each of the first and second acoustic ports 24, 48 can be configured to receive acoustic waves from the external environment and direct such waves into the acoustic path 22.

The acoustic path 22 further includes the outlet 28 (FIG. 5) disposed within the housing 12. The outlet 28 acoustically couples the acoustic path 22 to the inlet 20 of the microphone 18 using any suitable technique. In one or more embodiments, the inlet 20 of the microphone 18 can be disposed within the outlet 28 of the acoustic path 22. The outlet 28 can take any suitable shape and have any suitable dimensions.

Also acoustically coupled to the acoustic path 22 is the acoustic filter 30, which is disposed at least partially within the inner surface 44 of the top shell 14. In one or more embodiments, the acoustic filter 30 is disposed entirely within the top shell 14. Although depicted as being disposed at least partially within the inner surface 44 of the top shell 14, the acoustic filter 30 can be disposed at least partially within an inner surface 56 of the bottom shell 16. In one or more embodiments, the acoustic filter 30 is formed by a concavity 50 (FIG. 5) disposed in the inner surface 44 of the top shell 14 and the gasket 46 that is connected to the inner surface of the top shell.

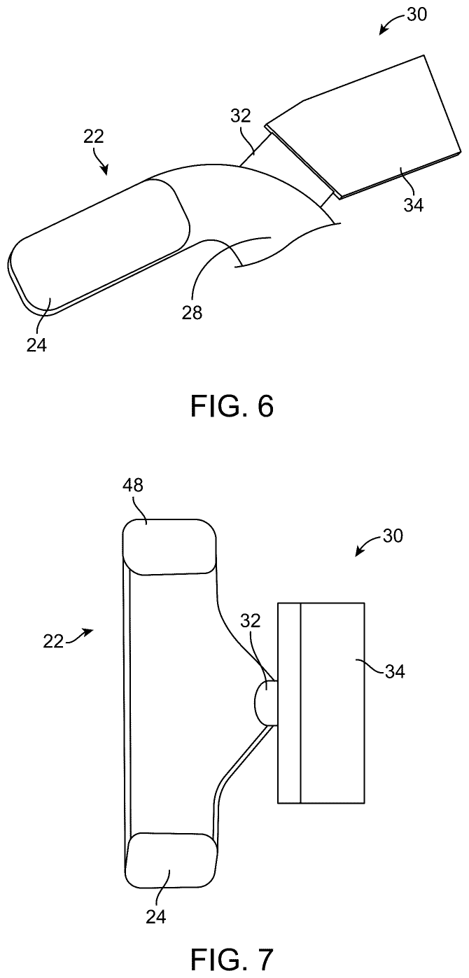

The acoustic filter 30 includes the neck 32 and the resonance cavity 34 acoustically coupled to the neck. The acoustic filter 30 is acoustically coupled to the acoustic path 22 via the neck 32 as shown in FIGS. 5-7 using any suitable technique.

The neck 32 of the acoustic filter 30 can take any suitable shape and have any suitable dimensions. In one or more embodiments, the neck 32 can take any elliptical cross-sectional shape. In one or more embodiments, the neck 32 can take a rectangular cross-sectional shape. The cross-sectional area of the neck 32 can be any suitable value. In one or more embodiments, the neck 32 has a cross-sectional area of at least 0.3 mm\hat{ }2 and no greater than 1 mm\hat{ }2. In one or more embodiments, the neck 32 has a constant cross-sectional area. In one or more embodiments, the cross-sectional area of the neck 32 various along a length of the neck. Further, the neck 32 can have any suitable length. In one or more embodiments, the neck 32 can have a length of at least 0.15 mm and no greater than 0.35 mm.

The cavity 34 of the acoustic filter 30 can also take any suitable shape and have any suitable dimensions. In one or more embodiments, the cavity 34 comprises an ellipsoidal (e.g., spherical) shape. In one or more embodiments, the cavity 34 comprises a pyramidal or parallelpiped shape as shown in FIGS. 3-7. Further, the cavity 34 can have any suitable volume. In one or more embodiments, the cavity 34 can have a volume of at least 1.5 mm\hat{ }3 and no greater than 3.5 mm\hat{ }3.

As mentioned herein, the acoustic filter 30 can be configured to reduce an intensity of acoustic waves sensed by the microphone 18 in a first frequency range. The first frequency range can include any suitable frequency values. In one or more embodiments, the first frequency range can include ultrasonic frequencies. In one or more embodiments, the first frequency range includes frequencies of at least 20 kHz and no greater than 50 kHz. Further, in one or more embodiments, the first frequency range can include frequencies of at least 25 kHz and no greater than 40 kHz.

In one or more embodiments, the acoustic filter 30 can be configured to be a Helmholtz resonator that includes any suitable resonance frequency as calculated utilizing the following ideal Helmholtz resonator equation:

$${f}_{0} = \frac{c}{2 π} \sqrt{\frac{A}{V \cdot ( L + 1.7 \cdot R )}} ;$$

where c is the speed of sound, A is the cross-sectional area of the neck 32, L is the length of the neck, R is the radius of the neck, and V is the volume of the cavity 34. In one or more embodiments, the resonance frequency of the acoustic filter 30 can be at least 20 kHz and no greater than 50 kHz.

The acoustic filter 30 can utilize any suitable technique such that it is configured to reduce the intensity of acoustic waves sensed by the microphone 18 in any selected frequency range. While not wishing to be bound by any particular theory, the acoustic filter 30 can be configured such that it redirects the ultrasonic energy from the microphone 18 to the cavity 34 of the filter. Simulations confirm that an amplitude of ultrasonic signals can be reduced at the frequencies where motion detectors operate as such motion detectors can act as ultrasonic acoustic field sources that can interfere with the acoustic signals produced by the microphone 18. In one or more embodiments, the acoustic filter 30 can absorb acoustic energy present in the acoustic waves that propagate within the acoustic path 22 to reduce the intensity of such acoustic energy or waves sensed by the microphone 18 in the selected frequency range.

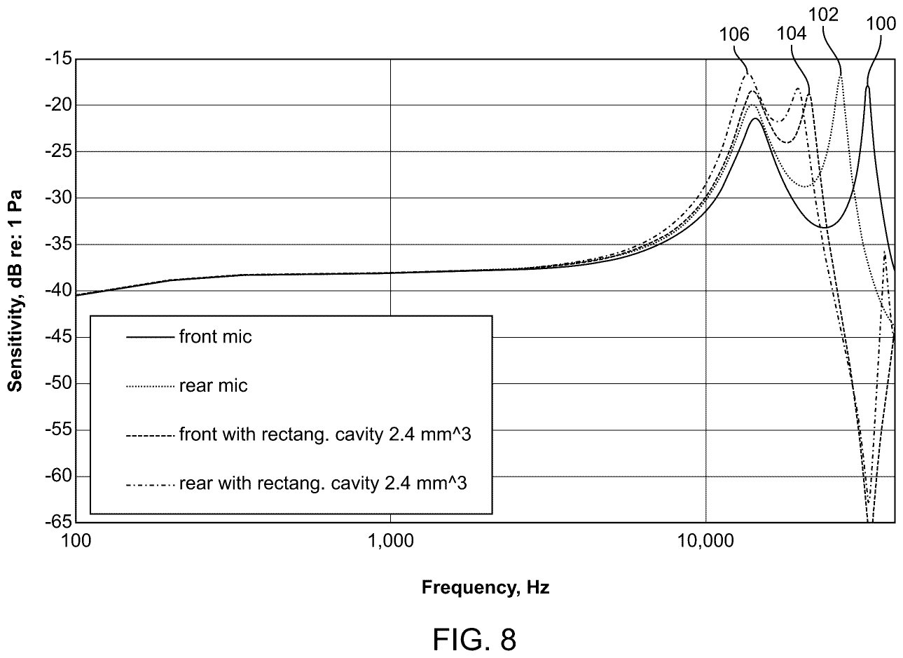

For example, FIG. 8 is a plot of simulated sensitivity of a Sonion P8 MEMS microphone (available from Sonion, Roskilde, Denmark) at audio and ultrasonic frequencies. An acoustic path utilized to obtain data shown in this plot was a split tube extending between two ports having a rectangular cross-section, where an average cross-sectional area of the acoustic path was about 0.97 mm\hat{ }2. Sides of the acoustic path were about 1.05 and 1.27 mm, and a length of one branch from a microphone to a port on one side was 3.2 mm.

Curve 100 shows the simulated sensitivity of a front microphone with no acoustic filter acoustically connected to an acoustic path of the microphone, curve 102 shows the simulated sensitivity of a rear microphone with no acoustic filter acoustically connected to an acoustic path of the rear microphone. Further, curve 104 shows the simulated sensitivity of the front microphone with an acoustic filter that is acoustically connected to the acoustic path of the front microphone that has rectangular resonance cavity of 2.4 mm\hat{ }3 in volume. In addition, curve 106 is a simulated sensitivity of the rear microphone with an acoustic filter acoustically coupled to the acoustic path of the rear microphone that has a rectangular cavity of 2.4 mm\hat{ }3 in volume.

At audio frequencies, specifically below 10 kHz, the sensitivity of each microphone appears to be unaffected by the presence of the acoustic filter in the acoustic path. For example, a change of approximately 2 dB at 10 kHz is present for both the front and rear microphones. At 30 kHz, however, the sensitivity peaks for each microphone are replaced with a reduction of at least −60 dB, which may block any ultrasonic peak from registering with the digital signal processing circuitry connected to the microphones. This frequency reduction can be adjusted by changing the ultrasonic filter's cavity volume and shape based upon the equation for an ideal Helmholtz resonator as previously described herein. The Helmholtz resonator frequency for the acoustic filters of the simulation shown in FIG. 8 were calculated to be 27.5 kHz, while the simulated sensitivity minimum was 33 kHz. The minimum frequency changes with cavity volume and adjacent acoustic path shape. In a spherical cavity, the sharp minimum is absent, replaced by a smooth decline of the curve. This can provide additional degrees of freedom for the cavity design.

Resultant sensitivity reduction at critical frequencies is summarized in Table 1 below. The term “sensitivity” means the voltage that the microphone produces per 1 Pa of pressure, converted to dB. Further, the term “reduction” means a difference between the sensitivity with the resonance cavity of the acoustic filter present and the sensitivity without the cavity present. The cavities of the acoustic filters can also be adjusted individually with each having its own target frequency. The shape of such cavities can be changed to trapezoidal or another smooth form to broaden the ultrasonic minimum and cover a wider range of frequencies with better sensitivity reduction.

TABLE 1

| Position-Frequency (kHz) | 35 | 32 | 40 |
|---|---|---|---|
| Front microphone (dB) | −4 | −42 | −4 |
| Rear microphone (dB) | −17 | −24 | −2 |

As mentioned herein, the ear-wearable electronic device 10 can include any suitable number of microphones. For example, as shown in FIG. 2, the device 10 includes the second microphone 40 disposed within the housing 12. The device 10 can further include a second acoustic path 60 acoustically coupled to the second microphone 40, and a second acoustic filter 66 acoustically coupled to the second acoustic path. All design considerations and possibilities described herein regarding the first microphone 18, the first acoustic path 22, and the first acoustic filter 30 apply equally to the second microphone 40 and its associated second acoustic path 60 and second acoustic filter 66.

The second microphone 40 includes an inlet 58. Further, the device 10 includes the second acoustic path 60 disposed at least partially within the housing 12 between the top and bottom shells 14, 16 and extending between an acoustic port 62 disposed at the outer surface 26 of the housing and an outlet 64 disposed within the housing that acoustically couples the second acoustic path 60 to the inlet 58 of the second microphone 40. In one or more embodiments, the second acoustic path 60 can include a second acoustic port 72 (FIG. 3) disposed at the outer surface 26 of the housing 12.

The device 10 can also include the second acoustic filter 66 disposed at least partially within the top shell 14. As shown in FIGS. 3 and 4, the second acoustic filter 66 includes a neck 68 and a resonance cavity 70 acoustically coupled to the neck. Further, the second acoustic filter 66 is acoustically coupled to the second acoustic path 60 via the neck 68. The second acoustic filter 66 is configured to reduce an intensity of acoustic waves sensed by the second microphone 40 in the first frequency range. In one or more embodiments, the second acoustic filter 66 can be configured to reduce an intensity of the acoustic waves sensed by the second microphone 40 in a second frequency range, where the second frequency range is different from the first frequency range.

The second acoustic filter 66 can be formed using any suitable technique. In one or more embodiments, the second acoustic filter 66 can be formed by a second concavity 67 disposed in the top shell 14 and a second gasket 69 connected to the inner surface 44 of the top shell. In one or more embodiments, the second gasket 69 can be a portion of the first gasket 46 or a separate gasket.

Although the embodiment of device 10 of FIGS. 1-5 includes a single acoustic filter 30, 66 acoustically coupled to each acoustic path 22, 60, in one or more embodiments, each acoustic path can include two or more acoustic filters that are acoustically coupled to the respective acoustic path using any suitable technique. In such embodiments, each acoustic filter acoustically coupled to an acoustic path can be configured to reduce an intensity of acoustic waves sensed by the associated microphone in a selected frequency range. For example, a first acoustic filter connected to the acoustic path can be configured to reduce an intensity of acoustic waves sensed by the associate microphone in a first frequency range, and a second acoustic filter acoustically connected to the acoustic path can be configured to reduce an intensity of acoustic waves sensed by the associated microphone in a second frequency range that is different from the first frequency range. In such embodiments, each acoustic filter can be configured to be a stop band filter that is configured to reduce the intensity of the acoustic waves sensed by the associated microphone in any desirable frequency range.

Returning to FIGS. 1 and 2, the ear-wearable device 10 can include one or more user input devices 74. In the illustrated embodiment, the user input devices 74 are disposed on the top shell 14 of the housing 12, but other placements of the user input devices are possible. The user input devices 74 may include buttons, switches, or the like, such as a first button and a second button. The user can interact with the user input devices 74 (e.g., by pressing one or more buttons) to adjust the volume, change one or more settings, or turn the ear-wearable electronic device 10 on or off.

As shown in FIG. 1, an earpiece 76 is coupled to the housing 12 by a cable 78. The earpiece 76 can include an earpiece housing 80 and a receiver (e.g., acoustic/vibration transducer 632 of FIG. 17) disposed at least partially within the earpiece housing. The receiver is configured to direct acoustic waves into the wearer's ear through a receiver path that extends between an outlet 82 disposed at an outer surface of the earpiece housing 80 and an inlet (not shown) disposed within the earpiece housing that is acoustically coupled to the receiver. This configuration is referred to as receiver-in-canal (RIC). Note that the features described herein, while shown implemented in a RIC device, are applicable to other configurations, such as in-the-canal (ITC) types of devices, in which the receiver is integrated into a housing that fits in the ear canal. In such device, the housing (which holds at least one externally-facing microphone) may be hidden in the canal or housing or have a visible part in the outer ear extending from the ear canal.

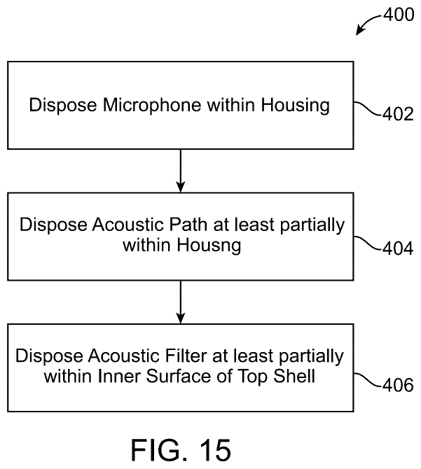

The ear-wearable electronic device 10 can be manufactured using any suitable technique. For example, FIG. 15 is a flowchart of one embodiment of a method 400 of forming the ear-wearable electronic device 10. Although described regarding the device 10 of FIGS. 1-5, the method 400 can be utilized to form any suitable ear-wearable electronic device. At 402, the microphone 18 is disposed within the housing 12 using any suitable technique. The acoustic path 22 can be disposed at least partially within the housing 12 using any suitable technique at 404 such that the acoustic path extends between the acoustic port 24 disposed at the outer surface 26 of the housing 12 and the outlet 28 disposed within the housing, where the outlet acoustically couples the acoustic path to the inlet 20 of the microphone 18. At 406, the acoustic filter 30 is disposed at least partially within the inner surface 44 of the top shell 14 of the housing 12 using any suitable technique. In one or more embodiments, the acoustic filter 30 can be disposed at least partially within the inner surface 44 of the top shell 14 by disposing the concavity 42 in the inner surface of the top shell that defines at least a portion of the neck 32 and the cavity 34 of the acoustic filter. In one or more embodiments, the acoustic filter 30 can be formed by the concavity 42 disposed in the inner surface 44 of the top shell 14 and the gasket 46 that is connected to the inner surface of the top shell. The concavity 42 can define at least a portion of the neck 32 and the cavity 34 of the acoustic filter 30.

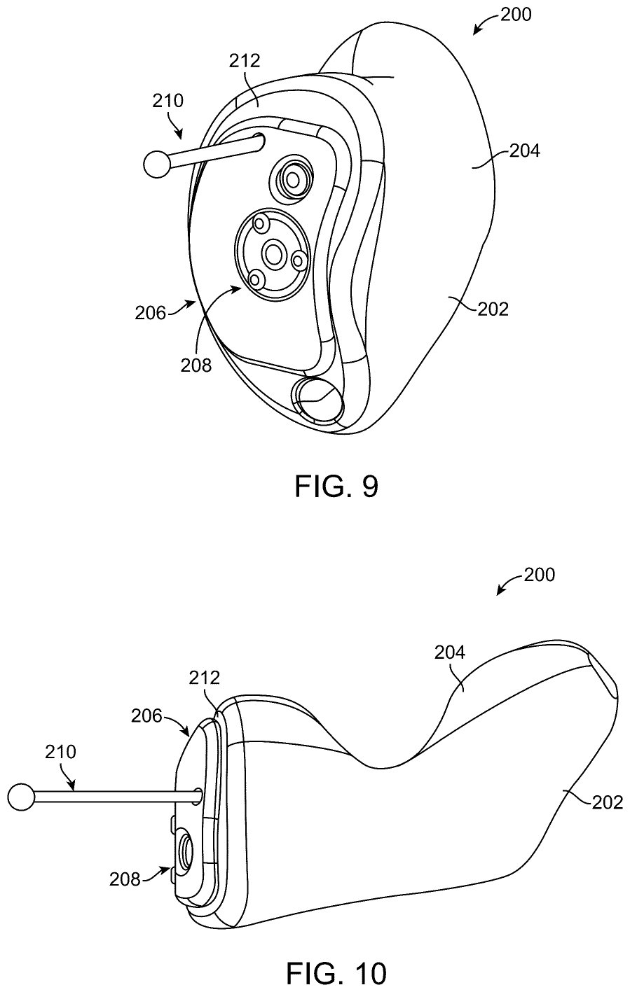

As mentioned herein, the various embodiments of ear-wearable electronic devices can include any suitable type of device. Although the device 10 of FIGS. 1-5 is configured to be disposed behind the ear of the wearer, in one or more embodiments, the device can be configured to be disposed at least partially within an ear canal of the wearer. For example, FIGS. 9 and 10 are various views of another embodiment of an ear-wearable electronic device 200. All design considerations and possibilities described herein regarding device 10 of FIGS. 1-5 apply equally to device 200 of FIGS. 9-10. The device 200 can represent a variety of different custom hearing devices and can be configured as an in-the-ear (ITE), in-the-canal (ITC), completely-in-canal (CIC) or invisible-in-canal (IIC) type hearing device, for example. Further, the device 200 can include any suitable ear-wearable electronic device 200, e.g., one or more embodiments of ear-wearable devices described in in U.S. Patent Application No. 63/555,206, filed Feb. 19, 2024, and entitled EAR-WEARABLE ELECTRONIC DEVICE INCLUDING FACEPLATE. The device 200 can further include any suitable electronic circuitry or components, e.g., the electronic circuitry or components of ear-wearable device 600 of FIG. 17.

The device 200 includes a shell 202, which, in one or more embodiments, can have a uniquely shaped outer surface 204 that corresponds uniquely to an ear geometry of a wearer of the device. For example, the shell 202 can be developed based on a mold taken from the wearer's ear. As such, the device 200 can be considered a custom ear-wearable electronic device. The shell 202 is configured to be disposed at least partially within an ear canal of the wearer.

The device 200 also includes a faceplate 206, which is shown connected to the shell 202 in FIGS. 9 and 10. The faceplate 206 can include a number of features, such as charge contacts 208 and a removal handle 210. The charge contacts 208 are configured to engage charge contacts of a charging unit when charging a battery (e.g., rechargeable power source 654 of FIG. 17) of the device 200. The faceplate 206 can be connected to the shell 202 using any suitable technique, e.g., adhering, mechanically fastening, friction or press fitting, bonding, welding, etc.

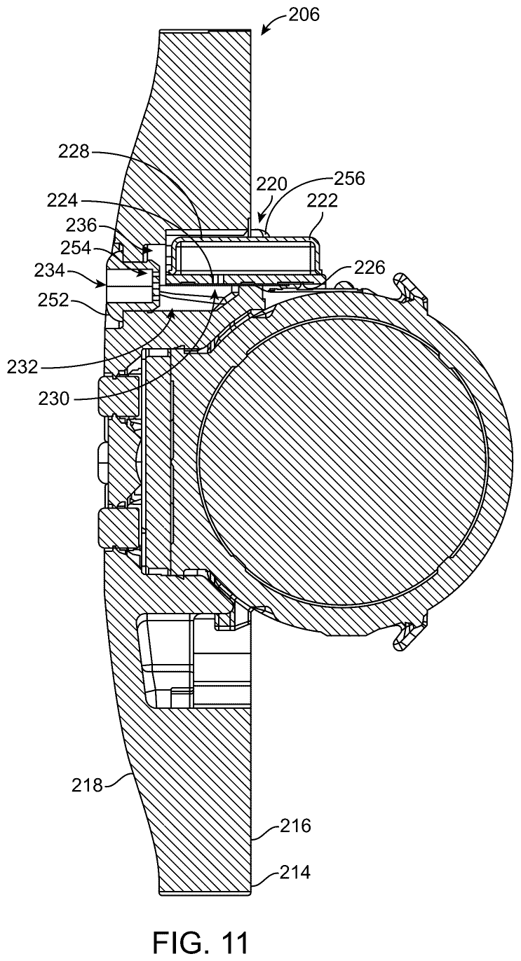

The shell 202 includes an end surface 212 having a predefined configuration that can be standardized across a family or families of devices 200. The end surface 212 is configured to matingly engage a mating surface 214 (FIG. 11) of the faceplate 206 to form an enclosure of the electronic device 200. Any suitable technique can be utilized to matingly engage the end surface 212 of the shell 202 with the mating surface 214 of the faceplate 206, e.g., one or more of the techniques described in U.S. Patent Publication No. 2023/0336928 A1, entitled COMPACT ELECTRO-MECHANICAL PACKAGING FOR A CUSTOM HEARING DEVICE.

Connected to the shell 202 of the device 200 is the faceplate 206. As shown in FIG. 11, the faceplate 206 includes an outer surface 218 and the inner surface 216. The faceplate 206 defines a cavity or pocket 220 disposed in the inner surface 216 of the faceplate. Disposed at least partially within the pocket 220 is a microphone 222. The microphone 222 includes an inlet 224. In one or more embodiments, the inlet 224 can be disposed in an outer major surface 226 of a housing 228 of the microphone 222. In one or more embodiments, the outer major surface 226 of the microphone 222 can partially occlude an outlet 230 of an acoustic path 232 of the device 200 as is further described herein.

The device 200 also includes the acoustic path 232 disposed at least partially within the faceplate 206 and extending between an acoustic port 234 disposed at the outer surface 218 of the faceplate and the outlet 230 disposed in the pocket 220 of the faceplate. The acoustic path 232 is acoustically coupled to the inlet 224 of the microphone 222 via the outlet 230. In one or more embodiments, the inlet 224 can be disposed in the pocket 220. In one or more embodiments, the inlet 224 can be disposed in the outlet 230 of the acoustic path 232. Further, in one or more embodiments, the acoustic path 232 is configured such that all acoustic waves propagating within the acoustic path pass directly from the acoustic path to the inlet 224 of the microphone 222.

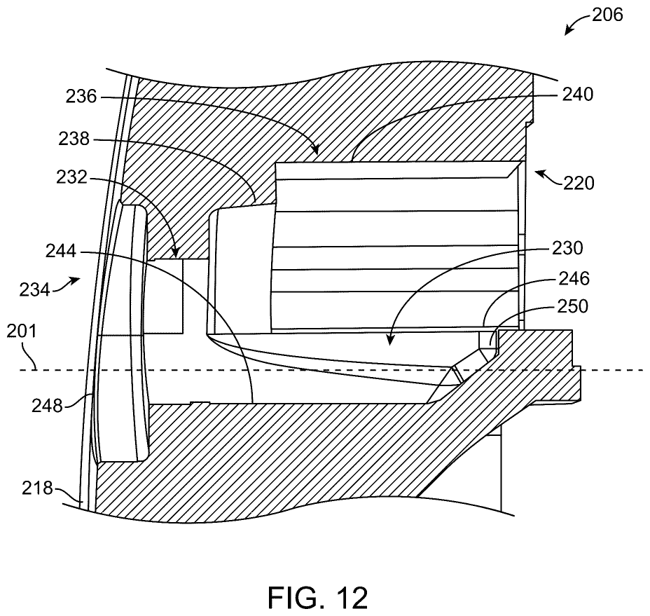

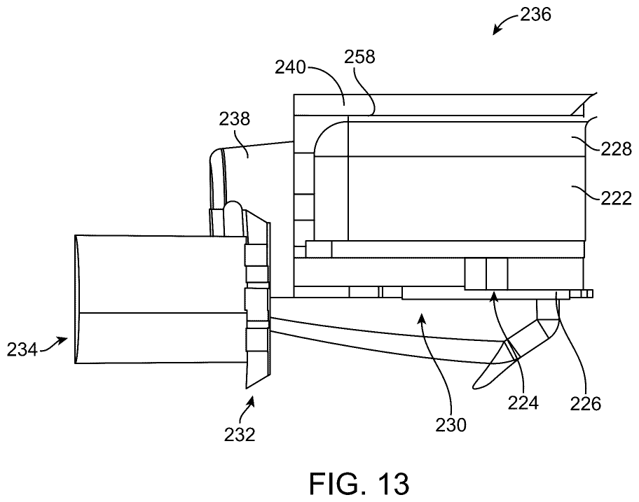

The ear-wearable electronic device 200 also includes an acoustic filter 236 disposed at least partially within the faceplate 206. As shown in FIG. 12, the acoustic filter 236 includes a neck 238 and a resonance cavity 240 acoustically coupled to the neck. The acoustic filter 236 is acoustically coupled to the acoustic path 232 via the neck 238 using any suitable technique. Further, in one or more embodiments, the acoustic filter 236 is configured to reduce an intensity of acoustic waves sensed by the microphone 222 (FIG. 13) in a first frequency range as is further described herein.

The faceplate 206 can take any suitable shape and have any suitable dimensions. Further, the faceplate 206 can include any suitable materials, e.g., at least one of an inorganic (e.g., metallic, ceramic) or polymeric material. In one or more embodiments, the faceplate 206 includes a nylon-based polyamide thermoplastic material. The faceplate 206 can be manufactured using any suitable technique, e.g., molding, injection molding, 3D printing, etc.

Defined by the faceplate 206 is the pocket 220, which can be disposed in the inner surface 216 of the faceplate using any suitable technique, e.g., etching, molding, etc. The pocket 220 can take any suitable shape and have any suitable dimensions. In one or more embodiments, the pocket 220 is configured to receive at least a portion of the microphone 222.

Any suitable portion or portions of the microphone 222 can be disposed within the pocket 220. In one or more embodiments, the microphone 222 is disposed completely or entirely within the pocket 220. The microphone 222 can include any suitable microphone, e.g., a MEMS microphone, an electret condenser microphone, co-joined microphone sets, etc. Although depicted as including one microphone 222, the device 200 can include any suitable number of microphones disposed in any suitable location on the device or disposed within the device. The microphone 222 can be electrically connected to a printed circuit board assembly (PCBA) (not shown) using any suitable technique, e.g., one or more of the techniques described in U.S. Patent Publication No. 2023/0336928 A1. In one or more embodiments, the microphone 222 is configured to convert acoustic waves that are directed into the microphone housing 228 through the inlet 224 of the microphone by the acoustic path 232. In one or more embodiments, the microphone 222 does not include a manifold that would, in currently-available products, form a portion of the acoustic path 232 but would be separate from the acoustic path. Instead, the acoustic path 232 solely directs acoustic waves to the microphone 222 without the assistance of a microphone manifold.

The microphone 222 includes the housing 228 that can take any suitable shape and have any suitable dimensions. The housing 228 includes the outer major surface 226 that can be disposed on a surface or surfaces of the pocket 220. The inlet 224 of the microphone 222 is disposed in any suitable portion of the outer major surface 226. In one or more embodiments, the outer major surface 226 can at least partially occlude the outlet 230 of the acoustic path 232 as is further described, e.g., in U.S. Patent Application No. ______ (Atty Docket No. ST1068PRV), entitled EAR-WEARABLE ELECTRONIC DEVICE INCLUDING FACEPLATE.

The acoustic path 232 is disposed at least partially within the faceplate 206. In one or more embodiments, the acoustic path 232 can be disposed completely or entirely within the faceplate 206. As shown in FIG. 12, which is a schematic cross view of a portion of the faceplate 206, where the microphone 222 is removed for clarity, the acoustic path 232 extends between the acoustic port 234 disposed at the outer surface 218 of the faceplate and the outlet 230 disposed in the pocket 220. The acoustic path 232 can take any suitable shape and have any suitable dimensions. In one or more embodiments, the acoustic path 232 has a cross-sectional area in a plane substantially orthogonal to an acoustic axis 201 that decreases in a direction from the acoustic port 234 to the outlet 230 of the acoustic path, where the acoustic path extends along the acoustic axis as shown in FIG. 12. In one or more embodiments, the acoustic path 232 has a constant cross-sectional area in the substantially orthogonal plane. Further, in one or more embodiments, the acoustic path 232 has a cross-sectional area in the substantially orthogonal plane that increases in the direction from the acoustic port 234 to the outlet 230.

In one or more embodiments, the acoustic path 232 is configured to direct acoustic waves incident on the acoustic port 234 to the inlet 224 of the microphone 222 (FIG. 11).

The acoustic path 232 can be defined by the faceplate 206. For example, the acoustic path 232 can be formed by disposing a channel in the faceplate 206 that extends from the acoustic port 234 to the outlet 230. In such embodiments, an inner surface 244 of the acoustic path 232 is formed by the material of the faceplate 206 and does not include any additional elements or components disposed in the acoustic path such as a microphone manifold. In one or more embodiments, the acoustic path 232 can be manufactured separately from the faceplate 206 and inserted into an opening in the faceplate using any suitable technique.

The acoustic port 234 disposed at the outer surface 218 of the faceplate 206 can take any suitable shape and have any suitable dimensions. In one or more embodiments, the acoustic port 234 can take an elliptical shape in a plane of the outer surface 218 of the faceplate 206.

Further, the outlet 230 of the acoustic path 232 can take any suitable shape and have any suitable dimensions. In one or more embodiments, the outlet 230 can take an elongated shape that is disposed in an inner surface 246 of the pocket 220 and the inner surface 244 of the acoustic path 232 such that the acoustic path is acoustically connected to the cavity via the outlet.

The outlet 230 can be disposed in any suitable portion or portions of the acoustic path 232. As shown in FIG. 12, the acoustic path 232 can extend between a first end 248 and a second end 250, where the first end is defined by the acoustic port 234 and the second end can be disposed within the faceplate 206. In one or more embodiments, the outlet 230 of the acoustic path 232 can be disposed at the second end 250 of the acoustic path. Further, in one or more embodiments, the outlet 230 can be disposed along the acoustic path 232 between its first end 248 and second end 250.

In one or more embodiments, the device 10 can also include a basket or filter 252 disposed at least partially within the acoustic port 234 as shown in FIG. 11. The basket 252 can be configured to collect debris entering the acoustic path 232 through acoustic port 234. The basket 252 can take any suitable shape and have any suitable dimensions. In one or more embodiments, the basket 252 can include one or more openings 254 configured to transmit acoustic waves that enter the acoustic port 234 into the acoustic path 232.

Acoustically coupled to the acoustic path 232 is the acoustic filter 236, which can include any suitable acoustic filter, e.g., acoustic filter 30 of FIGS. 2-7. All design considerations and possibilities described herein regarding the acoustic filter 30 of FIGS. 2-7 apply equally to acoustic filter 236 of FIGS. 11-13. As illustrated in FIG. 12, the acoustic filter 236 includes the neck 238 and the resonance cavity 240 acoustically coupled to the neck.

The acoustic filter 236 can be formed separately from the pocket 220 and acoustic path 232 and inserted into at least one of the pocket or the acoustic path using any suitable technique. In one or more embodiments, one or more portions of the pocket 220 and/or the acoustic path 232 can provide one or more portions of the neck 238 and/or cavity 240 of the acoustic filter 236. For example, as shown in FIG. 12, the pocket 220 can define at least a portion of the neck 238 disposed within the faceplate 206 of the device 200. The outlet 230 of the acoustic path 232 can be acoustically connected to the neck 238. Further, the pocket 220 can also define at least a portion of the cavity 240 of the acoustic filter 236 such that the cavity is disposed within the faceplate 206 of the device 200. In one or more embodiments, the cavity 240 of the acoustic filter 236 can be acoustically connected to the acoustic path 232 by the outlet 230 of the acoustic path. The cavity 240 of the acoustic filter 236 can be enclosed by the pocket 220 and the microphone 222. In one or more embodiments the cavity 240 can be acoustically sealed by a gasket 256 (FIG. 11) disposed between the housing 228 of the microphone 222 and the inner surface 216 of the faceplate 206 to acoustically seal the cavity of the acoustic filter.

The neck 238 and cavity 240 of the acoustic filter 236 can take any suitable shape, e.g., one or more of the shapes described herein regarding the neck 32 and cavity 34 of the acoustic filter 30 of FIGS. 2-7. Further, the neck 238 and the cavity 240 of the acoustic filter 236 can have any suitable dimensions, e.g., the same dimensions described herein regarding the neck 32 and cavity 34 of the acoustic filter 30. In one or more embodiments, the cavity 240 of the acoustic filter 236 can have a volume of at least about 1.5 mm\hat{ }3 and no greater than about 3.5 mm\hat{ }3. Further, the neck 238 of the acoustic filter 236 can have a length of at least about 0.15 mm and no greater than about 0.35 mm. The neck 238 can also include a cross-sectional area of at least about 0.3 mm\hat{ }2 and no greater than about 1 mm\hat{ }2.

Further, the acoustic filter 236 can be configured to reduce an intensity of acoustic waves sensed by the microphone 222 in any suitable first frequency range. In one or more embodiments, the first frequency range includes frequencies of at least about 20 kHz and no greater than about 50 kHz. In one or more embodiments, the first frequency range includes frequencies of at least about 20 kHz and no greater than about 40 kHz. The acoustic filter 236 can include a Helmholtz resonator that includes a resonance frequency of at least about 20 kHz and no greater than about 50 kHz.

The acoustic filter 236 can be disposed in any suitable portion or portions of the faceplate 206 and any suitable position relative to the microphone 222. In one or more embodiments, the microphone 222 can be disposed within the pocket 220 and the cavity 240 of the acoustic filter 236 such that the cavity is disposed at least partially around the microphone. For example, FIG. 13 is a schematic cross-section view of the microphone 222, the acoustic path 232, and the acoustic filter 236 in isolation from the faceplate 206. As can be seen in FIG. 13, the cavity 240 of the acoustic filter 236 is disposed at least partially around the microphone 222. In one or more embodiments, the microphone 222 is disposed within the cavity 240 of the acoustic filter 236. The microphone 222 can take any suitable volume of the cavity 240. In other words, the cavity 240 can be selected to have a desired volume such that the remaining space between the microphone 222 and an inner surface 258 of the cavity provides the desired acoustic properties of the acoustic filter 236.

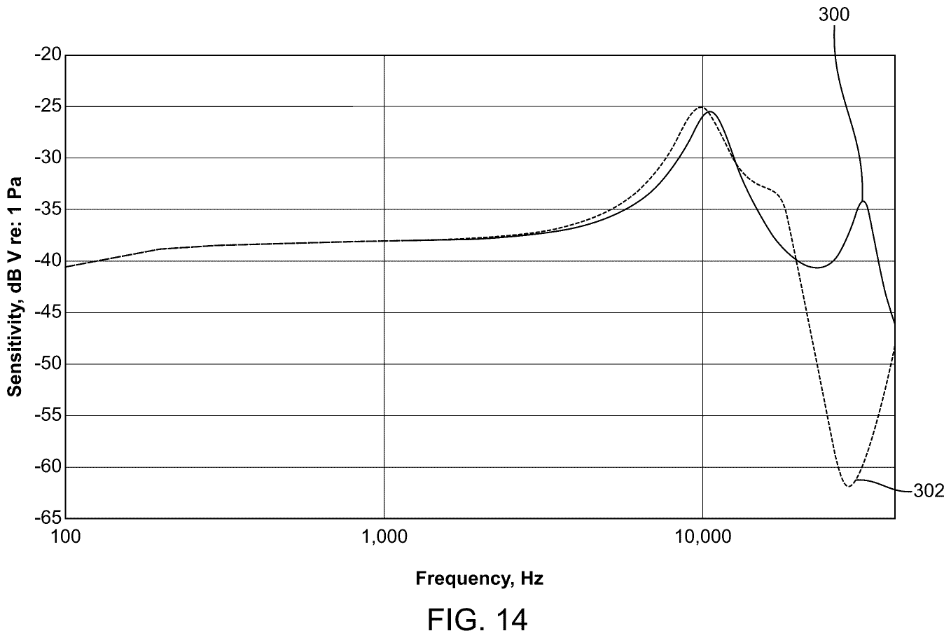

FIG. 14 is a plot of simulated sensitivity of the Sonion P8 MEMS microphone at various audio and ultrasonic frequencies as disposed in device 200. Curve 300 shows the simulated sensitivity of a front microphone with no acoustic filter acoustically connected to an acoustic path of the microphone. The acoustic path included a circular cylinder followed by a half-circular, slightly conical cylinder. The circular portion had a length of 0.97 mm and a diameter of 0.73 mm, while the half-circular cylindrical portion had a length of 1.73 mm and a width of 1 mm at its widest side. Further, curve 302 shows the simulated sensitivity of the microphone with an acoustic filter acoustically coupled to the acoustic path of the microphone. The cavity of the acoustic filter 236 has a volume of approximately 1 mm\hat{ }3.

At audio frequencies, specifically below 10 kHz, the sensitivity of the microphone appears to be unaffected by the presence of an acoustic filter coupled to the acoustic path. At approximately 30 kHz, however, the sensitivity for the microphone peak is replaced with a depth of at least 20 dB, which may block any ultrasonic peak from registering with the digital signal processing circuitry connected to the microphone. This frequency depth can be adjusted by changing the acoustic filter's cavity volume and shape based upon the equation for an ideal Helmholtz resonator as previously described herein. The Helmholtz resonator frequency for the acoustic filters of the simulation shown in FIG. 14 is calculated be approximately 31 kHz, while the simulated sensitivity minimum is at 28.9 kHz. The minimum frequency changes with cavity volume and adjacent acoustic path shape. In a spherical cavity, the sharp minimum is absent, replaced by smooth decline of the curve. This can provide additional degrees of freedom for the cavity design.

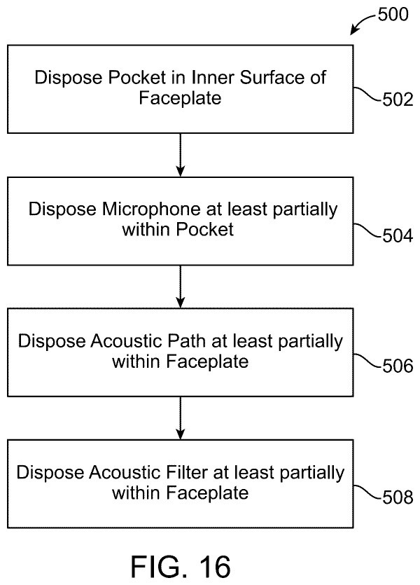

The ear-wearable electronic device 200 of FIGS. 9-13 can be manufactured using any suitable technique. For example, FIG. 16 is a flowchart of one embodiment of a method 500 that can be utilized to form the ear-wearable electronic device 200 of FIGS. 9-13. Although described regarding ear-wearable electronic device 200 of FIGS. 9-13, the method 500 can be utilized to form any suitable ear-wearable electronic device. At 502, the method 500 includes disposing the pocket 220 in the inner surface 216 of the faceplate 206 using any suitable technique. The microphone 222 can be disposed at least partially within the pocket 220 at 504 such that the inlet 224 of the microphone is disposed within the pocket using any suitable technique. Further, at 506, the acoustic path 232 can be disposed at least partially within the faceplate 206 using any suitable technique such that the acoustic path extends between the acoustic port 234 disposed at the outer surface 218 of the faceplate 206 and the outlet 230 disposed in the pocket 220. The acoustic path 232 is acoustically coupled to the inlet 224 of the microphone 222 via the outlet 230 of the acoustic path. At 508, the acoustic filter 236 can be disposed at least partially within the faceplate 206 using any suitable technique. In one or more embodiments, the acoustic filter 236 can be disposed in the faceplate 206 such that the cavity 240 of the filter is disposed at least partially around the microphone 222.

In one or more embodiments, the acoustic filter 236 can be disposed in the faceplate 206 when the pocket 220 is also disposed in the faceplate. In one or more embodiments, the pocket 220 forms at least a portion of the cavity 240 of the acoustic filter 236. In one or more embodiments, the pocket 220 forms at least a portion of the neck 238 of the acoustic filter 236. Further, the acoustic path 232 can form at least a portion of the neck 238 of the acoustic filter 236. In one or more embodiments, the pocket 220, the acoustic path 232, and the acoustic filter 236 can be formed at the same time and be interconnected. For example, the faceplate 206 can be molded, machined, or printed such that the pocket 220, the acoustic path 232, and the acoustic filter 236 are formed during processing as a continuous passageway through the faceplate. Similarly, the faceplate 206 can be 3D printed such that the pocket 220, the acoustic path 232, and the acoustic filter 236 are formed as a continuous passageway.

The various embodiments of ear-wearable devices described herein can include any suitable electronic components or circuitry. For example, FIG. 17 is a block diagram that illustrates one embodiment of a system and ear-wearable electronic device 600 in accordance with any of the embodiments disclosed herein. The device 600 includes a housing 612 configured to be worn in, on, or about an ear of a wearer. The device 600 shown in FIG. 17 can represent a single hearing device configured for monaural or single-ear operation or one of a pair of hearing devices configured for binaural or dual-ear operation. Various components are situated or supported within or on the housing 612. The housing 612 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The device 600 includes a processor 601 operatively coupled to a main memory 602 and a non-volatile memory 603. The processor 601 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 601 can include or be operatively coupled to main memory 602, such as RAM (e.g., DRAM, SRAM). The processor 601 can include or be operatively coupled to non-volatile (persistent) memory 603, such as ROM, EPROM, EEPROM or flash memory.

The device 600 includes an audio processing facility operably coupled to, or incorporating, the processor 601. The audio processing facility includes audio signal processing circuitry (e.g., analog front-end, analog-to-digital converter, digital-to-analog converter, DSP, and various analog and digital filters), a microphone arrangement 618, and an acoustic/vibration transducer 632 (e.g., loudspeaker, receiver, bone conduction transducer, motor actuator). The acoustic transducer 632 produces amplified sound inside of the ear canal. The microphone arrangement 618 can include one or more discrete microphones or a microphone array(s) (e.g., configured for microphone array beamforming). Each of the microphones of the microphone arrangement 618 can be situated at different locations of the housing 612. It is understood that the term microphone used herein can refer to a single microphone or multiple microphones unless specified otherwise. The microphone 618 is operatively coupled to the processor 601 and is configured to direct a microphone signal to the processor, which in turn directs a receiver signal to the transducer 632 that is based at least in part on the microphone signal.

At least one of the microphones 618 may be configured as a reference microphone producing a reference signal in response to external sound outside an ear canal of a user. Generally, at least one the reference microphones 618 (also referred to as an externally facing microphones) is acoustically coupled to ambient air outside the housing 612 via an acoustic pathway or acoustic path 622 and an acoustic port 624. The acoustic port 624 allows air to pass between two parts of the housing 612 or may be formed within one part of the housing.

The device 600 may also include a user control interface 607 operatively coupled to the processor 601. The user control interface 607 is configured to receive an input from the wearer of the device 600. The input from the wearer can be any type of user input, such as a touch input, a gesture input, or a voice input. The user control interface 607 may be configured to receive an input from the wearer of the device 600.

The device 600 can include one or more communication devices 616. For example, the one or more communication devices 616 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 600 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 616 may also include wired communications, e.g., universal serial bus (USB) and the like.

The device 600 also includes a power source, which can be a conventional battery, a rechargeable battery (e.g., a lithium-ion battery), or a power source including a supercapacitor. In the embodiment shown in FIG. 17, the device 600 includes a rechargeable power source 654 that is operably coupled to power management circuitry for supplying power to various components of the device 600. The rechargeable power source 654 is coupled to charging circuity 606. The charging circuitry 606 is, for example, electrically coupled to charging contacts on the housing 612 that are configured to electrically couple to corresponding charging contacts of a charging unit when the device 600 is placed in the charging unit.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable electronic device including a housing having a top shell and a bottom shell, a microphone disposed within the housing and having an inlet, and an acoustic path disposed at least partially within the housing between the top and bottom shells and extending between an acoustic port disposed at an outer surface of the housing and an outlet disposed within the housing that acoustically couples the acoustic path to the inlet of the microphone. The device further includes an acoustic filter disposed at least partially within an inner surface of the top shell, where the acoustic filter includes a neck and a resonance cavity acoustically coupled to the neck. The acoustic filter is acoustically coupled to the acoustic path via the neck. Further, the acoustic filter is configured to reduce an intensity of acoustic waves sensed by the microphone in a first frequency range.

Example Ex2. The device of Ex1, where the acoustic path includes a second acoustic port disposed at the outer surface of the housing.

Example Ex3. The device of any one of Ex1-Ex2, where the first frequency range includes frequencies of at least about 20 kHz and no greater than about 50 kHz.

Example Ex4. The device of Ex3, where the first frequency range includes frequencies of at least about 20 kHz and no greater than about 40 kHz.

Example Ex5. The device of any one of Ex1-Ex4, where the cavity of the acoustic filter includes a volume of at least about 1.5 mm\hat{ }3 and no greater than about 3.5 mm\hat{ }3.

Example Ex6. The device of any one of Ex1-Ex5, where the neck of the acoustic filter includes a length of at least about 0.15 mm and no greater than about 0.35 mm.

Example Ex7. The device of any one of Ex1-Ex6, where the neck of the acoustic filter includes a cross-sectional area of at least about 0.3 mm\hat{ }2 and no greater than about 1 mm\hat{ }2.

Example Ex8. The device of any one of Ex1-Ex7, where the neck includes an elliptical cross-sectional shape.

Example Ex9. The device of any one of Ex1-Ex8, where the acoustic filter is formed by a concavity disposed in the inner surface of the top shell and a gasket connected to the inner surface of the top shell.

Example Ex10. The device of any one of Ex1-Ex9, where the cavity of the acoustic filter includes a spherical shape.

Example Ex11. The device of any one of Ex1-Ex10, where the acoustic filter includes a Helmholtz resonator having a resonance frequency of at least about 20 kHz and no greater than about 50 kHz.

Example Ex12. The device of any one of Ex1-Ex11, where the microphone defines a first microphone, the acoustic path defines a first acoustic path, and the acoustic filter defines a first acoustic filter. The device further includes a second microphone disposed within the housing and having an inlet, a second acoustic path disposed at least partially within the housing between the top and bottom shells and extending between an acoustic port disposed at the outer surface of the housing and an outlet disposed within the housing that acoustically couples the second acoustic path to the inlet of the second microphone, and a second acoustic filter disposed at least partially within the top shell and including a neck and a resonance cavity acoustically coupled to the neck. Further, the second acoustic filter is acoustically coupled to the second acoustic path via the neck, and the second acoustic filter is configured to reduce an intensity of acoustic waves sensed by the second microphone in a first frequency range.

Example Ex13. The device of Ex12, where the second acoustic path includes a second acoustic port disposed at the outer surface of the housing.

Example Ex14. The device of any one of Ex12-Ex13, where the second frequency range includes frequencies of at least about 20 kHz and no greater than about 50 kHz.

Example Ex15. The device of Ex14, where the second frequency range includes frequencies of at least about 20 kHz and no greater than about 40 kHz.

Example Ex16. The device of any one of Ex12-Ex15, where the cavity of the second acoustic filter includes a volume of at least about 1.5 mm\hat{ }3 and no greater than about 3.5 mm\hat{ }3.

Example Ex17. The device of any one of Ex12-Ex16, where the neck of the second acoustic filter includes a length of at least about 0.15 mm and no greater than about 0.35 mm.

Example Ex18. The device of any one of Ex12-Ex17, where the neck of the second acoustic filter includes a cross-sectional area of at least about 0.3 mm\hat{ }2 and no greater than about 1 mm\hat{ }2.

Example Ex19. The device of any one of Ex12-Ex18, where the neck of the second acoustic filter includes an elliptical cross-sectional shape.

Example Ex20. The device of any one of Ex12-Ex18, where the second acoustic filter is formed by a second concavity disposed in the top shell and a second gasket connected to the inner surface of the top shell.

Example Ex21. The device of any one of Ex12-Ex20, where the cavity of the second acoustic filter includes a spherical shape.

Example Ex22. The device of any one of Ex12-Ex21, where the second acoustic filter includes a Helmholtz resonator having a resonance frequency of at least about 20 kHz and no greater than about 50 kHz.

Example Ex23. The device of any one of Ex1-Ex22, further including an earpiece that is coupled to the housing by a cable. The earpiece includes an earpiece housing and a receiver disposed at least partially within the earpiece housing. The receiver is configured to direct acoustic waves into a wearer's ear through a receiver path that extends between an outlet disposed at an outer surface of the earpiece housing and an inlet disposed within the earpiece housing that is acoustically coupled to the receiver.

Example Ex24. An ear-wearable electronic device including a faceplate having an outer surface and an inner surface, where the faceplate defines a pocket disposed in the inner surface of the faceplate; and a microphone disposed at least partially within the pocket and including an inlet disposed within the pocket. The device also includes an acoustic path disposed at least partially within the faceplate and extending between an acoustic port disposed at the outer surface of the faceplate and an outlet disposed in the pocket, where the acoustic path is acoustically coupled to the inlet of the microphone via the outlet; and an acoustic filter disposed at least partially within the faceplate and having a neck and a resonance cavity acoustically coupled to the neck. Further, the acoustic filter is acoustically coupled to the acoustic path via the neck, and the acoustic filter is configured to reduce an intensity of acoustic waves sensed by the microphone in a first frequency range.

Example Ex25. The device of Ex24, where the cavity of the acoustic filter is disposed at least partially around the microphone.

Example Ex26. The device of any one of Ex24-Ex25, where the pocket forms at least a portion of the cavity of the acoustic filter.

Example Ex27. The device of any one of Ex24-Ex26, where the first frequency range includes frequencies of at least about 20 kHz and no greater than about 50 kHz.

Example Ex28. The device of Ex27, where the first frequency range includes frequencies of at least about 20 kHz and no greater than about 40 kHz.

Example Ex29. The device of any one of Ex24-Ex28, where the cavity of the acoustic filter includes a volume of at least about 1.5 mm\hat{ }3 and no greater than about 3.5 mm\hat{ }3.

Example Ex30. The device of any one of Ex24-Ex29, where the neck of the acoustic filter includes a length of at least at least about 0.15 mm and no greater than about 0.35 mm.

Example Ex31. The device of any one of Ex24-Ex30, where the neck of the acoustic filter includes a cross-sectional area of at least about 0.3 mm\hat{ }2 and no greater than about 1 mm\hat{ }2.

Example Ex32. The device of any one of Ex24-Ex31, where the neck includes an elliptical cross-sectional shape.

Example Ex33. The device of any one of Ex24-Ex32, further including a gasket disposed on the inner surface of the faceplate and that is configured to seal the cavity of the acoustic filter.

Example Ex34. The device of any one of Ex24-Ex33, where the cavity includes a spherical shape.

Example Ex35. The device of any one of Ex24-Ex34, where the acoustic filter includes a Helmholtz resonator including a resonance frequency of at least at least about 20 kHz and no greater than about 50 kHz.

Example Ex36. The device of any one of Ex24-Ex35, further including a shell configured to be disposed at least partially within an ear canal of a wearer. The shell includes an end surface that is configured to matingly engage a mating surface of the faceplate to form an enclosure of the device.

Example Ex37. A method of forming an ear-wearable electronic device, including disposing a microphone within a housing, where the housing includes a top shell and a bottom shell; disposing an acoustic path at least partially within the housing such that it extends between an acoustic port disposed at an outer surface of the housing and an outlet disposed within the housing that acoustically couples the acoustic path to an inlet of the microphone; and disposing an acoustic filter at least partially within an inner surface of the top shell of the housing. The acoustic filter includes a neck and a resonance cavity acoustically coupled to the neck. The acoustic filter is acoustically coupled to the acoustic path via the neck. Further, the acoustic filter is configured to reduce an intensity of acoustic waves sensed by the microphone in a first frequency range.

Example Ex38. The method of Ex37, where disposing the acoustic filter includes disposing a concavity in the inner surface of the top shell that defines at least a portion of the neck and the cavity of the acoustic filter.

Example Ex39. The method of Ex38, where disposing the acoustic filter further includes disposing a gasket on the inner surface of the top shell, where the concavity and the gasket define the neck and cavity of the acoustic filter.

Example Ex40. A method of forming an ear-wearable electronic device, including disposing a pocket in an inner surface of a faceplate; disposing a microphone at least partially within the pocket such that an inlet of the microphone is disposed within the pocket; and disposing an acoustic path at least partially within the faceplate, where the acoustic path extends between an acoustic port disposed at an outer surface of the faceplate and an outlet disposed in the pocket. The acoustic path is acoustically coupled to the inlet of the microphone via the outlet. The method further includes disposing an acoustic filter at least partially within the faceplate. The acoustic filter includes a neck and a resonance cavity acoustically coupled to the neck. Further, the acoustic filter is acoustically coupled to the acoustic path via the neck, and the acoustic filter is configured to reduce an intensity of acoustic waves sensed by the microphone in a first frequency range.

Example Ex41. The method of Ex40, where the cavity of the acoustic filter is disposed at least partially around the microphone.

Example Ex42. The method of Ex41, where the pocket disposed in the faceplate forms at least a portion of the cavity of the acoustic filter.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device comprising:
a housing comprising a top shell and a bottom shell;
a microphone disposed within the housing and comprising an inlet;
an acoustic path disposed at least partially within the housing between the top and bottom shells and extending between an acoustic port disposed at an outer surface of the housing and an outlet disposed within the housing that acoustically couples the acoustic path to the inlet of the microphone; and
an acoustic filter disposed at least partially within an inner surface of the top shell and comprising a neck and a resonance cavity acoustically coupled to the neck, wherein the acoustic filter is acoustically coupled to the acoustic path via the neck, and further wherein the acoustic filter is configured to reduce an intensity of acoustic waves sensed by the microphone in a first frequency range.

2. The device of claim 1, wherein the acoustic path comprises a second acoustic port disposed at the outer surface of the housing.

3. The device of claim 1, wherein the first frequency range comprises frequencies of at least about 20 kHz and no greater than about 50 kHz.

4. The device of claim 1, wherein the cavity of the acoustic filter comprises a volume of at least about 1.5 mm\hat{ }3 and no greater than about 3.5 mm\hat{ }3.

5. The device of claim 1, wherein the neck of the acoustic filter comprises a length of at least about 0.15 mm and no greater than about 0.35 mm.

6. The device of claim 1, wherein the microphone defines a first microphone, the acoustic path defines a first acoustic path, and the acoustic filter defines a first acoustic filter, wherein the device further comprises:
a second microphone disposed within the housing and comprising an inlet;
a second acoustic path disposed at least partially within the housing between the top and bottom shells and extending between an acoustic port disposed at the outer surface of the housing and an outlet disposed within the housing that acoustically couples the second acoustic path to the inlet of the second microphone; and
a second acoustic filter disposed at least partially within the top shell and comprising a neck and a resonance cavity acoustically coupled to the neck, wherein the second acoustic filter is acoustically coupled to the second acoustic path via the neck, and further wherein the second acoustic filter is configured to reduce an intensity of acoustic waves sensed by the second microphone in a second frequency range.

7. The device of claim 6, wherein the second frequency range comprises frequencies of at least about 20 kHz and no greater than about 50 kHz.

8. The device of claim 6, wherein the cavity of the second acoustic filter comprises a volume of at least about 1.5 mm\hat{ }3 and no greater than about 3.5 mm\hat{ }3.

9. The device of claim 6, wherein the neck of the second acoustic filter comprises a length of at least about 0.15 mm and no greater than about 0.35 mm.

10. An ear-wearable electronic device comprising:
a faceplate comprising an outer surface and an inner surface, wherein the faceplate defines a pocket disposed in the inner surface of the faceplate;
a microphone disposed at least partially within the pocket and comprising an inlet disposed within the pocket;
an acoustic path disposed at least partially within the faceplate and extending between an acoustic port disposed at the outer surface of the faceplate and an outlet disposed in the pocket, wherein the acoustic path is acoustically coupled to the inlet of the microphone via the outlet; and
an acoustic filter disposed at least partially within the faceplate and comprising a neck and a resonance cavity acoustically coupled to the neck, wherein the acoustic filter is acoustically coupled to the acoustic path via the neck, and further wherein the acoustic filter is configured to reduce an intensity of acoustic waves sensed by the microphone in a first frequency range.

11. The device of claim 10, wherein the cavity of the acoustic filter is disposed at least partially around the microphone.

12. The device of claim 10, wherein the pocket forms at least a portion of the cavity of the acoustic filter.

13. The device of claim 10, wherein the first frequency range comprises frequencies of at least about 20 kHz and no greater than about 50 kHz.

14. The device of claim 10, wherein the cavity of the acoustic filter comprises a volume of at least about 1.5 mm\hat{ }3 and no greater than about 3.5 mm\hat{ }3.

15. The device of claim 10, wherein the neck of the acoustic filter comprises a length of at least at least about 0.15 mm and no greater than about 0.35 mm.

16. The device of claim 10, further comprising a shell configured to be disposed at least partially within an ear canal of a wearer, the shell comprising an end surface that is configured to matingly engage a mating surface of the faceplate to form an enclosure of the device.

17. The device of claim 10, wherein the cavity comprises a spherical shape.

18. A method of forming an ear-wearable electronic device, comprising:
disposing a microphone within a housing, wherein the housing comprises a top shell and a bottom shell;
disposing an acoustic path at least partially within the housing such that it extends between an acoustic port disposed at an outer surface of the housing and an outlet disposed within the housing that acoustically couples the acoustic path to an inlet of the microphone; and
disposing an acoustic filter at least partially within an inner surface of the top shell of the housing, wherein the acoustic filter comprises a neck and a resonance cavity acoustically coupled to the neck, wherein the acoustic filter is acoustically coupled to the acoustic path via the neck, and further wherein the acoustic filter is configured to reduce an intensity of acoustic waves sensed by the microphone in a first frequency range.

19. The method of claim 17, wherein disposing the acoustic filter comprises disposing a concavity in the inner surface of the top shell that defines at least a portion of the neck and the cavity of the acoustic filter.

20. The method of claim 17, wherein disposing the acoustic filter further comprises disposing a gasket on the inner surface of the top shell, wherein the concavity and the gasket define the neck and cavity of the acoustic filter.
